(19) United States
(12) Patent Application Publication
(10) Pub. No.: US 2004/0039613 A1
(43) Pub. Date: Feb. 26, 2004

(54) Passenger status based on flight status information

(76) Inventors: Higinio O. Maycotte, Austin, TX (US); Ernesto Vazquez, Austin, TX (US); James L. Stanislaus, Austin, TX (US); Michael J. Scott, Austin, TX (US)

Correspondence Address: TOLER & LARSON & ABEL L.L.P., PO BOX 29567, AUSTIN, TX, 78755-9567, US

(21) Appl. No.: 10/300,136

(22) Filed: Nov. 20, 2002

Related U.S. Application Data
(60) Provisional application No. 60/405,938, filed on Aug. 26, 2002.

(51) Int. Cl. G06F 17/60

(52) U.S. Cl. 705/5

(57) ABSTRACT

A method for determining flight reservation data associated with reservations of a set of airline passengers is disclosed. The method also determines flight status data for at least one airplane associated with the reservations of the set of airline passengers. Further, the method determines a passenger status for each passenger in the set of airline passengers based on the flight reservation data and based on the flight status data. In another embodiment, a system is disclosed. The system includes a customer reservation subsystem, a disruption prediction subsystem responsive to the customer reservation system, an external communication subsystem responsive to the disruption prediction subsystem, and an alternate travel solution subsystem responsive to the disruption prediction subsystem. The alternate travel solution subsystem provides input to the external communication subsystem.

### CROSS-REFERENCE TO RELATED APPLICATION(S)

The present application claims priority from U.S. provisional patent application no. 60/405,938, filed Aug. 26, 2002, entitled “Monitoring The Status and Situation of National Air Space Stakeholders”, by Maycotte et al., which is incorporated by reference herein in its entirety.

This application is related to co-pending U.S. Application filed concurrently with the present application and having attorney docket number 1003-0003, entitled “Automated Collection of Flight Reservation System Data,” by Maycotte et al.

This application is related to co-pending U.S. Application filed concurrently with the present application and having attorney docket number 1003-0004, entitled “System and Method to Support End-to-End Travel Service Including Disruption Notification and Alternative Flight Solutions,” by Maycotte et al.

### BACKGROUND

1. Field of the Invention

The present invention relates generally to systems and methods involving flight and related information.

2. Description of the Related Art

Imagine you are on your way to the airport about one hour before your flight is scheduled to depart. Unknown to you, the flight has been cancelled, but you continue to rush, park your car and sprint through security only to arrive at a 20-person line at the gate. By the time you get to the gate agent, the next available flight has been booked full and you've missed the next two connections. Your trip has now been delayed 4-5 hours.

Currently, flight data is monitored and distributed to airlines by the FAA while passenger data is aggregated by Customer Reservation Systems (CRS) such as SABRE and Galileo, and utilized by travel agents. Today there is no efficient integration of the two independent systems. For instance, when the FAA makes decisions about flights to be cancelled, neither the FAA nor the airlines have any requirement (nor is there any automatic notice) to provide this data to a travel agent or its customers. It is usually the passenger who notifies the travel agent after the airlines has had sufficient time to re-book and re-schedule passengers at their will.

Airline delays are at an all time high. Over a quarter of flights were delayed in the year 2000. The traveling public loses over $2 billion due to the chronic flight delays that plague the domestic air travel industry.

Now imagine the desirability of a new service where you are on your way to the airport and you receive a phone or electronic message from your travel agent informing you of the flight cancellation and your subsequent re-booking on another airline just 30 minutes after your original departure time. You are able to make your connecting flight and no trip time has been lost due to flight delays.

Travel agents distribute a substantial portion of the air travel market. Due to airline commission reductions, these agents are seeking additional value added services.

As a result, it would be desirable for travelers to receive a maximum level of alternate flight options when a delay occurs, and have their problem resolved automatically by their travel agent. Accordingly, there is a need for improved systems and methods for monitoring flight status.

### SUMMARY

In a particular embodiment, a method for determining flight reservation data associated with reservations of a set of airline passengers is disclosed. The method also determines flight status data for at least one airplane associated with the reservations of the set of airline passengers. Further, the method determines a passenger status for each passenger in the set of airline passengers based on the flight reservation data and based on the flight status data.

In another embodiment, a system is disclosed. The system includes a customer reservation subsystem, a disruption prediction subsystem responsive to the customer reservation system, an external communication subsystem responsive to the disruption prediction subsystem, and an alternate travel solution subsystem responsive to the disruption prediction subsystem. The alternate travel solution subsystem provides input to the external communication subsystem.

### BRIEF DESCRIPTION OF THE DRAWINGS

FIG. 1 shows a general process that illustrates transportation paths.

FIG. 2 is an illustrative end-to-end trip lifecycle.

FIG. 3 is a plurality of potential disruption points along a travel path.

FIG. 4 is an illustrative system for monitoring travel paths.

FIG. 5 is an illustrative system to monitor flight travel.

FIG. 6 is a flow diagram that illustrates a method of determining and responding to a travel disruption.

FIG. 7 is a flow diagram that illustrates the method for monitoring the status and situation of any National Air Space (NAS) stakeholder.

FIG. 8 is a passenger situational display interface (PSDI) that is used to display status and situation of any National Air Space (NAS) stakeholder.

FIG. 9 is a flow diagram that illustrates a method for responding to a travel disruption.

FIG. 10 is a detailed example of a system to provide monitoring and communication of disruption events.

FIG. 11 is a flow chart that further illustrates a method of providing alternative travel arrangements.

The use of the same reference symbols in different drawings indicates similar or identical items.

### DETAILED DESCRIPTION

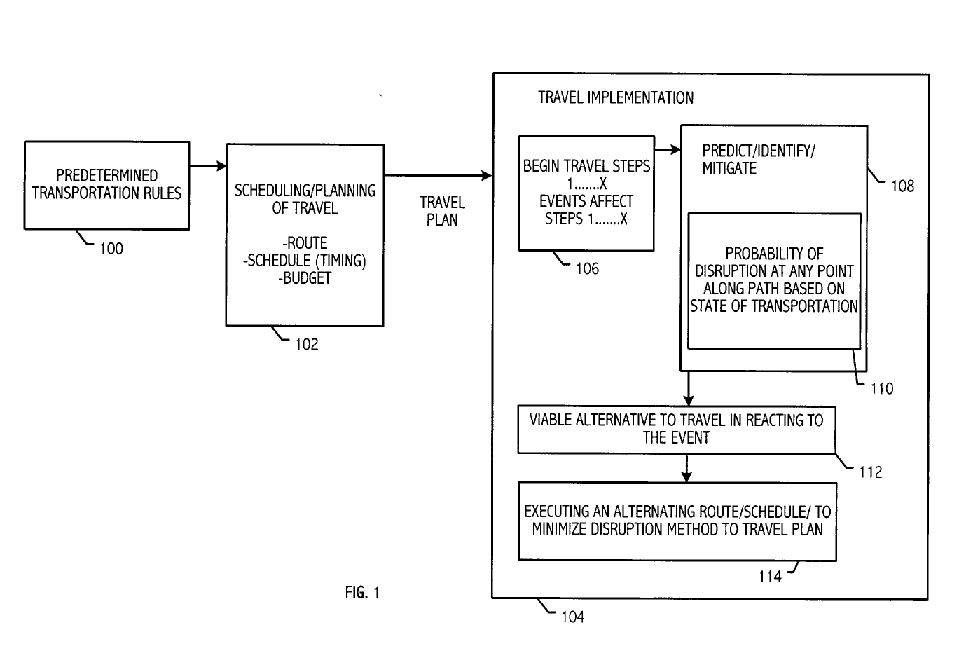

Referring to FIG. 1, a general process that illustrates transportation paths is shown. A predetermined set of transportation rules are generated at 100 and input to a process for scheduling/planning of travel, at 102. The scheduling/planning function 102 includes determining appropriate travel route, scheduling and budget allocations. The output of the scheduling/planning function 102 is a travel plan which is received as an input into the travel implantation process 104.

During the travel implementation process, physical travel, such as airplane flights or other transportation beginning at 106. During the physical travel path, various disruptive events may affect the travel. A prediction engine 108 may be used to determine and predict the probability of disruptions at various points along the travel path based on a state of transportation, at 110. In the case where a travel disruption is predicted with a high degree of certainty, a viable alternative to travel is created to respond to the disruption event, at 112. The alternative travel path is provided and an alternative route/schedule may be executed to minimize or at least reduce the disruption from the original travel plan, at 114.

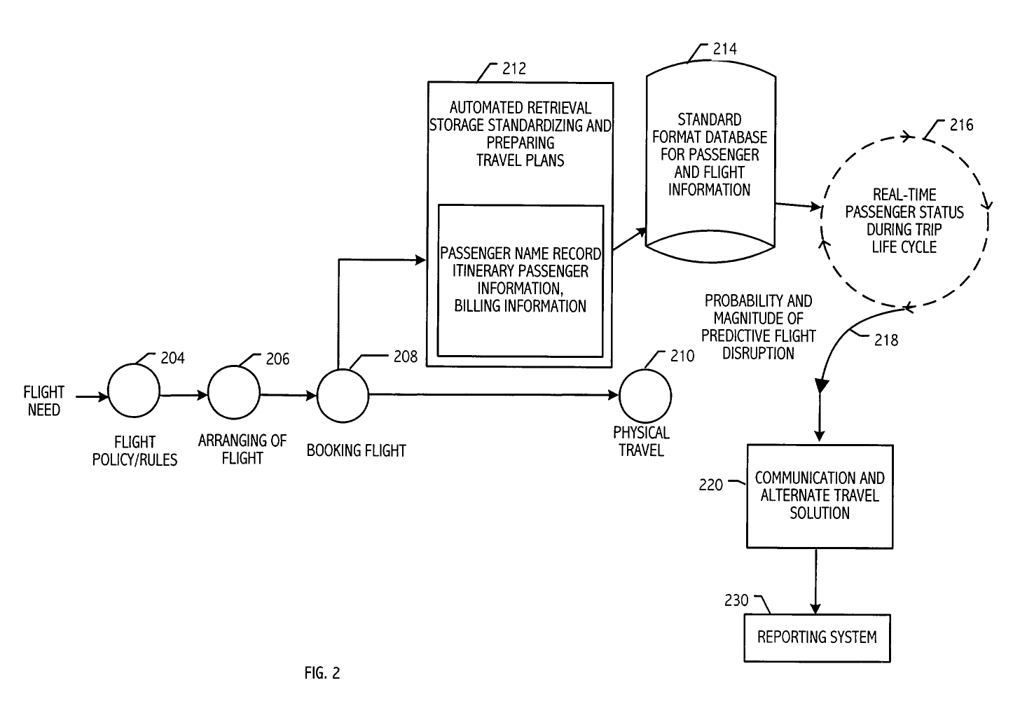

Referring to FIG. 2, an illustrative end-to-end trip lifecycle is shown. The lifecycle includes an original need for a flight, such as a need determined by a passenger arranging a trip. The flight need is input to a set of flight policy and rules determination, at 204, and a flight is arranged, at 206. The arranging step 206 includes pricing and availability determination. As part of the flight arrangement, other factors may be considered such as the probability of a flight disruption based on historical and other disruption predication information. The arranged flight is then booked, at 208, and physical travel for that flight occurs, at 210. After booking a flight, at 208, a computer-based system 212 may be used to automatically retrieve and store, as well as standardize travel plans. As part of the automated retrieval and standardizing process, a passenger name record, itinerary passenger information, and billing information is received, stored, and then standardized for further analysis. The standard format for passenger flight information is then transferred by the system 212 to a database 214.

Real-time passenger status during the trip is continually determined and updated through a physical travel life cycle at 216. One output of the real-time passenger status is a probability and magnitude of a potential flight disruption 218. The probability and magnitude data 218 is fed to a communication and alternate travel solution module 220. Output from the communication and alternate travel solution module 220, such as a notification of a disruption event accompanied by alternate travel plans, is sent to a reporting system 230. The reporting system 230 may be used to communicate with passengers, airlines, and travel agents.

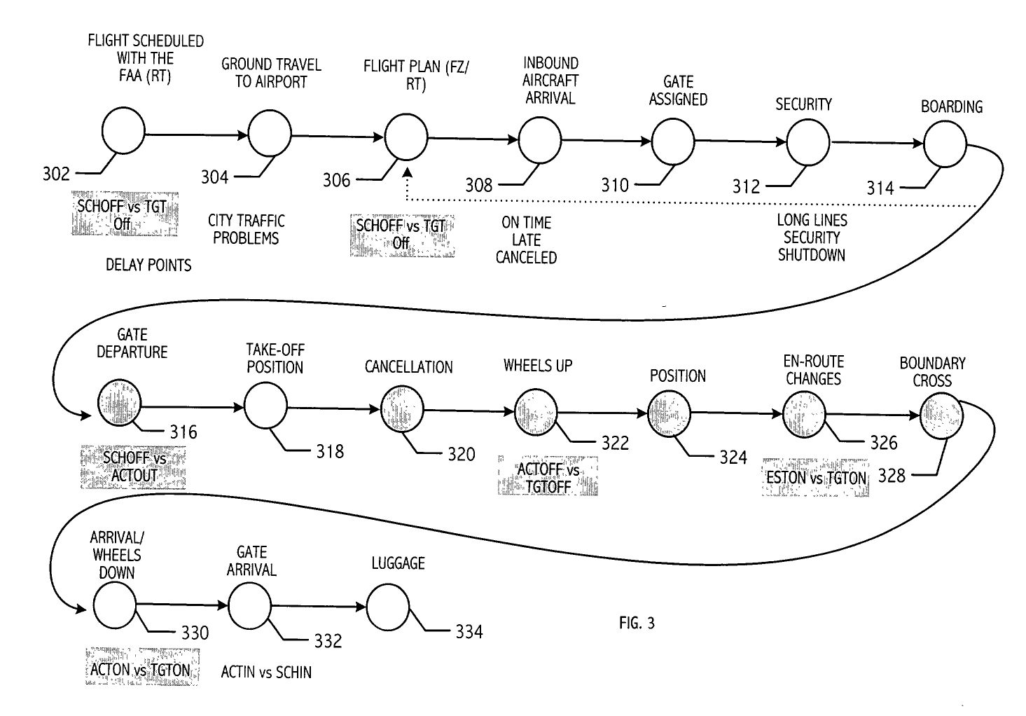

Referring to FIG. 3, a plurality of potential disruption points along a travel path is illustrated. A first potential disruption point is the point when the flight scheduled with the FAA, at 302. The next potential disruption event point is the ground travel to airport point 304. Additional potential disruption points include flight plan 306, inbound aircraft arrival 308, gate assigned point 310, security clearance point 312, flight boarding point 314, gate departure 316, take-off position 318, cancellation 320, wheels up 322, flight position 324, en-route changes 326, boundary cross 328, arrival/wheels down 330, gate arrival 332, and luggage available 334. At each of the disruption points, such as those illustrated in FIG. 3, a measurement may be taken comparing real-time actual location versus the travel plan and target. In the case where a flight is delayed, cancelled or where a disruption occurs, such as weather condition, maintenance issue, or any other scenario affecting travel plans, a disruption condition or a high probability of a disruption condition occurring may be determined. By determining disruption condition events at each of a plurality of potential disruption points, an early indication of disruption may be determined.

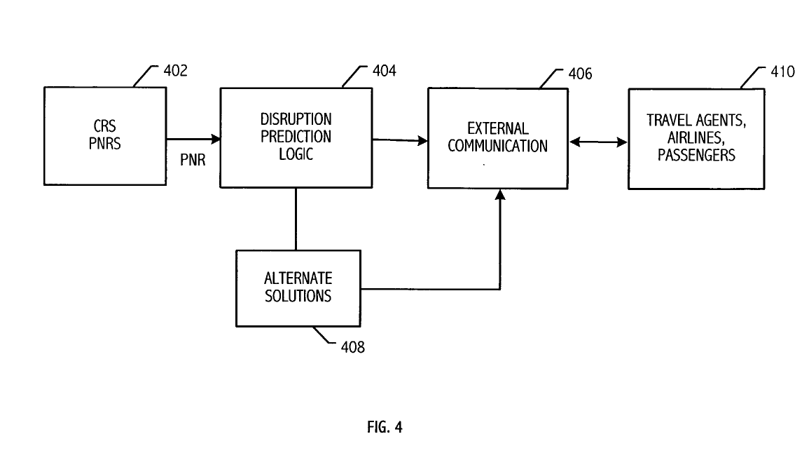

Referring to FIG. 4, an illustrative system for monitoring travel paths, determining disruption events, and for providing communications with travel industry stakeholders is illustrated. The system includes a customer reservation system 402, a disruption prediction logic subsystem 404, an external communication subsystem 406, alternate travel solutions system 408, and external systems 410, including travel agent systems, airlines and those used by passengers. The customer reservation system (CRS) 402 includes passenger name records and may be an automated airline system, such as that provided by Sabre. The disruption prediction logic 404 retrieves the passenger name records (PNR) from the customer reservation system 402 and processes those passenger name records. In the case where a disruption event is detected by prediction logic 404, an alternative travel solution is determined by the alternate solution system 408 and notification of the disruption event as well as the alternate solution is provided by the external communication system 406. Such communication provides notification of disruption events, such as notice of delay condition to travel agents, airlines, and flight passengers 410.

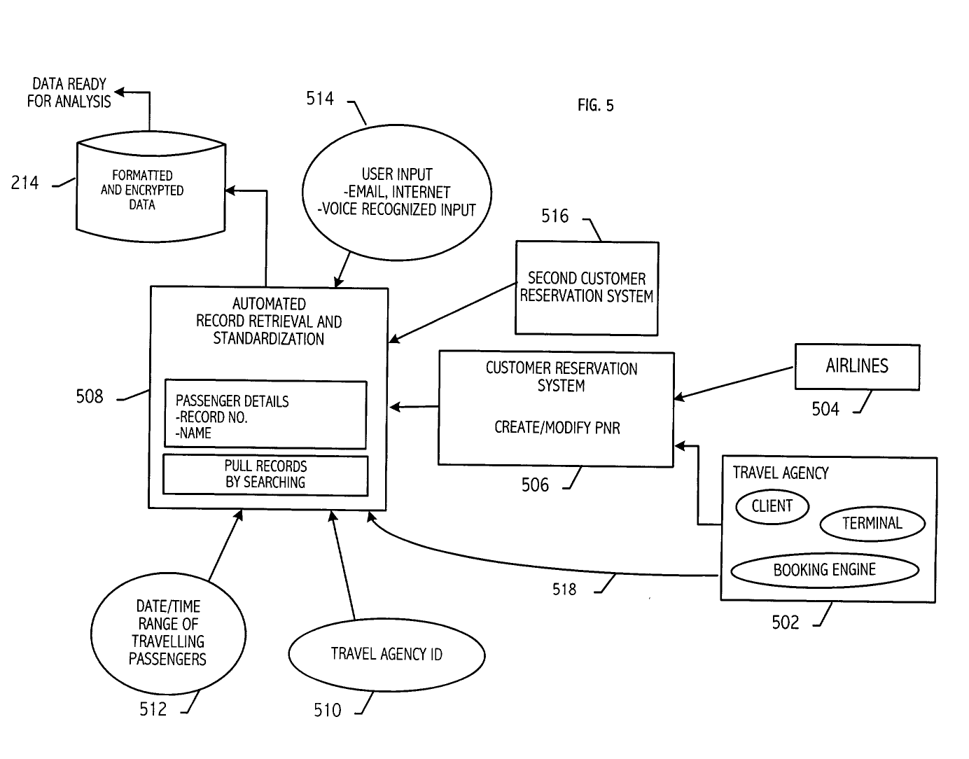

Referring to FIG. 5, an illustrative system to monitor flight travel is shown. The system includes a travel agency system 502, airline systems 504, customer reservation system 506, automated record retrieval standardization module 508, and an optional second customer reservation system 516. The automated record retrieval and standardization system 508 receives a travel agency ID 510, date/time range of traveling passengers 512, and user input such as received via email, internet, and voice recognized user input 514. The illustrated system also includes data storage 214 that includes the formatted and encrypted/standardized data which is ready for analysis.

The travel agency computer system 502 may include a travel agency terminal, an internet booking engine, and a client software module. The travel agency computer system 502 is also connected to the airline customer reservation system (CRS) 506, so that a travel agent at a terminal may schedule and book flights. The term travel agent includes any advocate of a potential passenger that has authority to create or modify a travel plan. The customer reservation system 506 may be used to create and modify passenger name records (PNR) and receives information, including modified PNRs, from the airlines 504. The illustrated system may also be used with additional customer reservation systems, such as the second customer reservation system 516. The travel agency computer system 502 also has a direct data feed 518 to the automated record retrieval and standardization system 508. The direct data feed 518, in a particular example may be a direct or remote communication path, such as a local or wide area network. The automated record retrieval and standardization system 508 may be used to retrieve and pull flight records by using various searching methods, may determine passenger detail such as name and various record numbers, and may reformat text and data to provide for a standardized format of information.

The automated record retrieval and standardization system 508 receives a travel agency ID 510 and a time range of traveling passengers 512 including date of travel information. With the travel agency ID 510 and the date and time range of traveling passengers 512, a subset of the records from the CRS 506 and/or CRS 516 may be searched through to pull a defined and filtered set of selected passenger records. This subset of passengers based on a particular travel agency defined criteria is then standardized and may optionally be encrypted for subsequent analysis after storage in the database 214. The automated record retrieval and standardization system 508 also may receive user input such as via certain internet travel sites, email, and alternative user input, such as via voice recognition. The automated record retrieval and standardization system 508 utilizes all such received information to produce a set of passenger information that may be easily analyzed for various record requests.

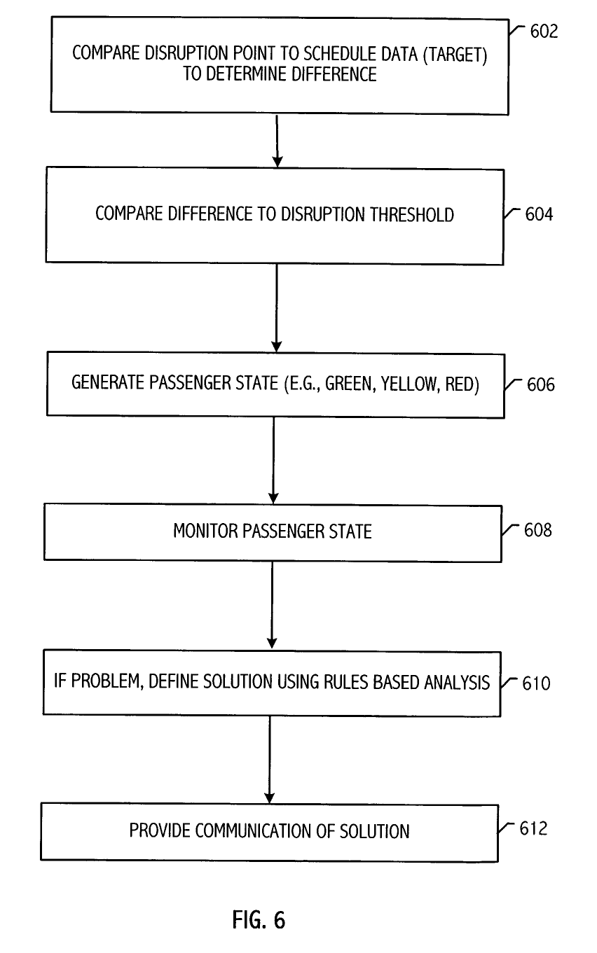

Referring to FIG. 6, a method of determining and responding to a travel disruption is illustrated. In a particular disruption point along a travel path, the schedule data, also referred to as target data, is compared to actual monitored real time data to determine a difference measurement, at 602. The difference measurement is then compared to a disruption threshold, at 604. A passenger state is then generated, at 606. The passenger state may be a particular disruption activity level. One method of indicating disruption potential is by providing a set of three different disruption levels. In this example, a green status indicates little or no disruption, a yellow status would indicate a warning of potential disruption, and a red indication would mean a determined or very high likelihood disruption event condition. While the illustrated method uses three different disruption levels, it should be understood that a set of two or many more different disruption levels may be used to indicate a disruption condition. The passenger state information is monitored, at 608, and if a problem is detected, an alternate solution using a rules-based analysis is determined, at 610. An example of an alternate solution could be taking a different flight or may be scheduling alternate means of transportation, such as a bus, train rental car, etc. The alternate solution in response to the disruption event is then communicated, at 612.

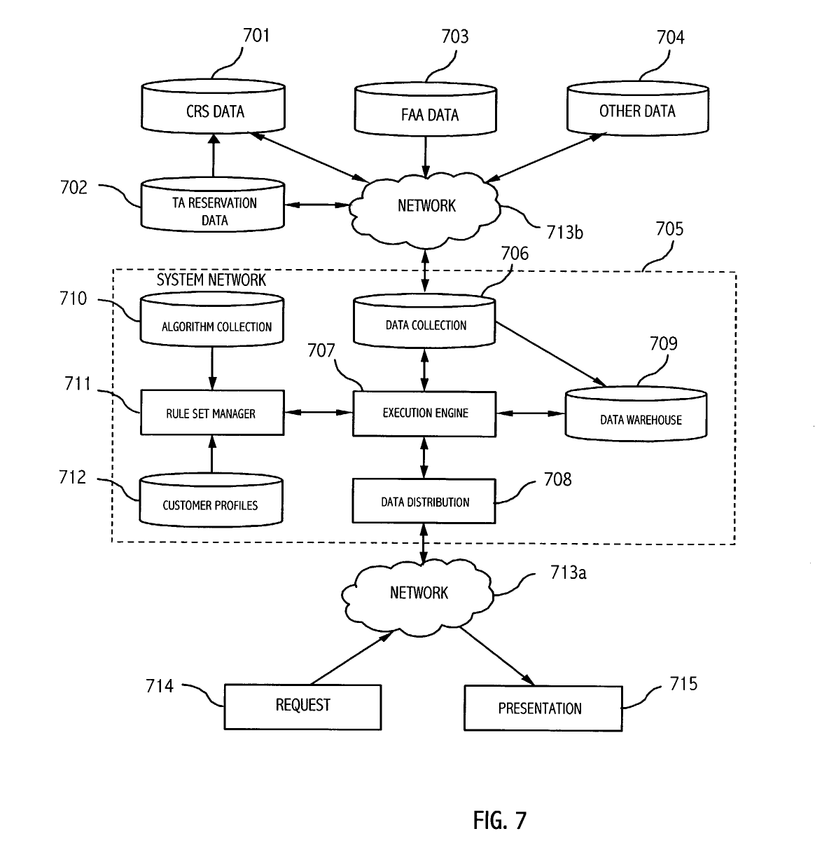

Referring to FIG. 7, a method for monitoring the status and situation of any National Air Space (NAS) stakeholder, including any passenger, before, during and after that stakeholder enters NAS is illustrated. The stakeholder status is determined by aggregating Travel Agency (TA) passenger reservation data at 702, central reservation system (CRS) data at, 701, real-time enhanced traffic management system (ETMS), air traffic data from the FAA, at 703, and other data including real-time weather data, airport status, etc. at, 704.

This data is aggregated across public and private networks 713b and received into the system network, at 705. All data is then collected, parsed, sorted and stored at 706. This data is then combined with various algorithms 710, profile data 712, and warehoused historical data 709, to yield a stakeholder status. Based on the stored algorithms 710 and the stakeholder status, certain reactions take place in an execution engine, at 707. The execution engine then disseminates the appropriate data either automatically or in response to a client request, at 714, via the data distribution system, at 708. This data is then distributed across public and private networks 713a to a client for presentation, at 715.

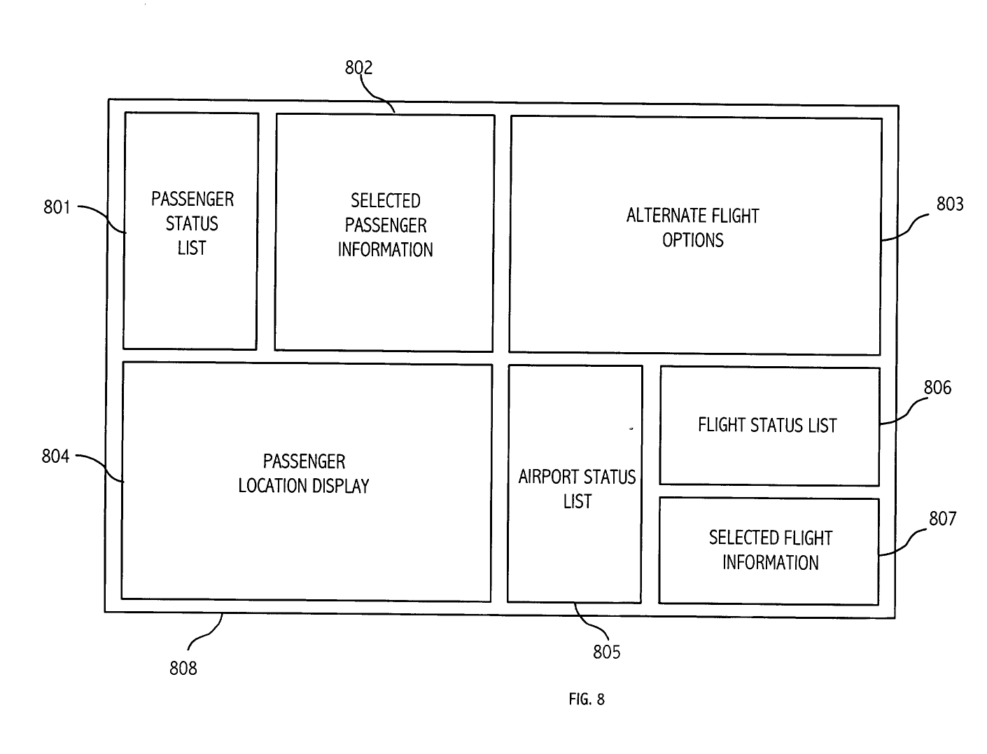

Referring to FIG. 8, the passenger situational display interface (PSDI) is a client system used to display status and situation of any National Air Space (NAS) stakeholder. The Java client displays passenger location 804, airport status 805, flight status list 806, selected flight information 807, flight passenger list 801, selected passenger information 802, and the alternate flight options 803. This information is also available for any computing platform via Microsoft Windows Client, HTML, XML, WAPI and others. This PSDI will allow additional windows and information to be displayed such as weather, news, pricing information and others.

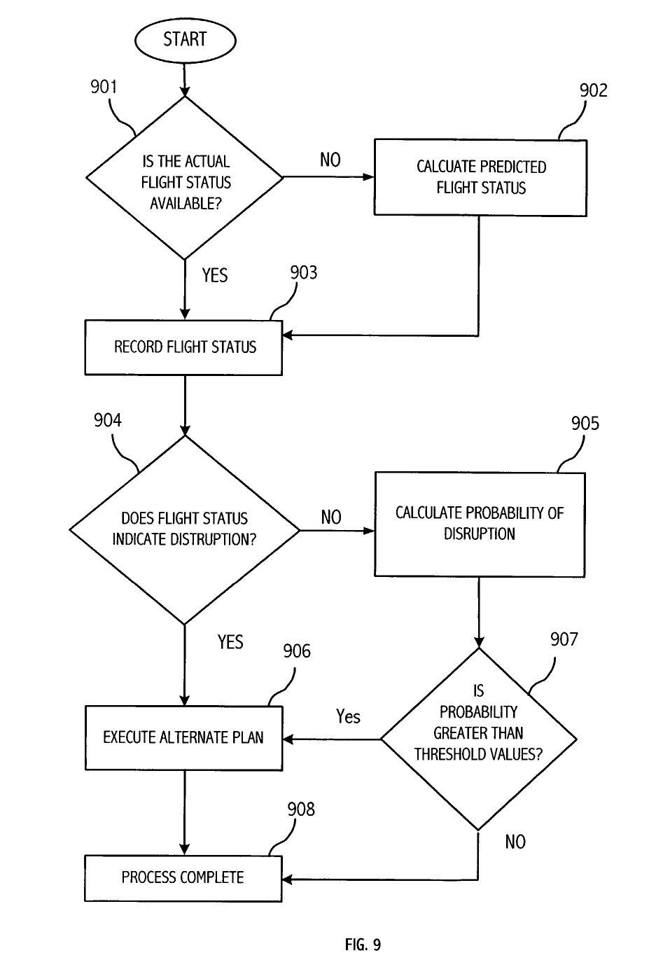

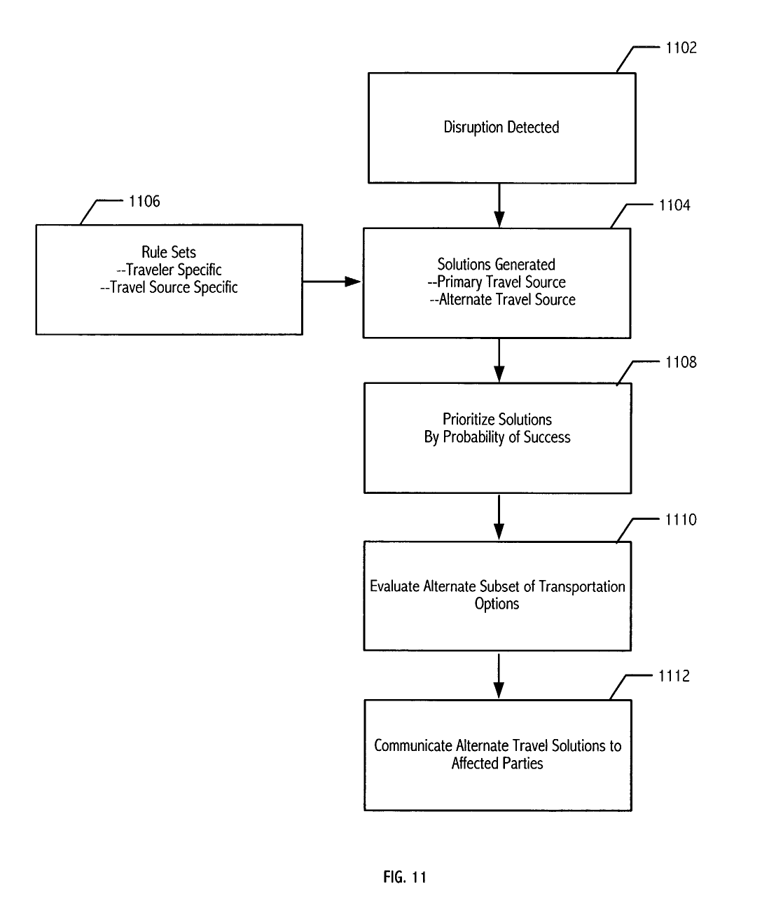

Referring to FIG. 9, when a passenger has an active reservation, a method for determining whether alternate flights should be booked for that particular passenger is illustrated. If the flight status is available, at 901, then flight status is recorded, at 903. If the flight status is not available, a predicted flight status is calculated, at 902. If the determined status indicates a disruption event, such as a flight cancellation or delay, at 904, then an alternate travel plan is arranged, at 906. If the status does not indicate a disruption, then the probability of a disruption is calculated, at 905. If the calculated probability is greater than a predetermined threshold value 907, then an alternate travel plan for the passenger is determined and executed, at 906. An example of a method of determining and executing an alternate travel plan is illustrated below with reference to FIG. 11. If the probability threshold is less than the predetermined threshold value, then the process is complete, at 908.

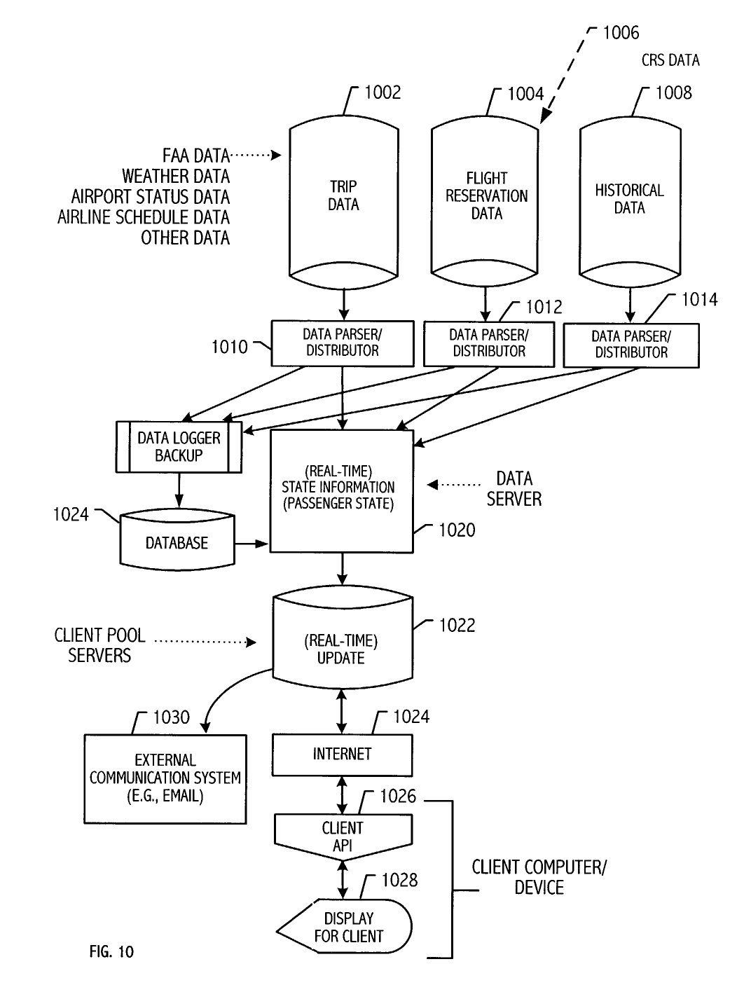

Referring to FIG. 10, a detailed example of a system to provide monitoring and communication of disruption events is shown. The system includes a real-time state information logic module 1020, and an updated real-time status system 1022. The real-time state information logic routine 1020 may be embedded within a data server. The real-time state information logic receives input from various data parsers/distributors, such as data parser/distributors 1010, 1012, and 1014. The first data parser/distributor 1010 receives trip data 1002, the second data parser/distributor 1012 receives flight reservation information 1004, and the third data parser/distributor 1014 receives historical data 1008. The flight reservation information 1004 may be retrieved from customer reservation system data 1006. The trip data 1002 may be received from various sources including FAA data, weather data, airport status data, airline schedule data, and other data that can affect on the travel. A data logger and backup function is also implemented and receives data from the various parsers 1010, 1012, and 1014. The data logger/backup also includes and may be implemented using a database 1024 to store needed information. A pool of client servers may be used in a particular implementation to perform the real-time update function 1022. During a real-time update, when a change in passenger state disruption level is determined, a notification and/or communication event may be triggered. Such communication may be a proprietary system handled over the internet 1024 using a client application program interface (API) 1026 and displayed on a particular client device 1028. Alternatively, a communication of the disruption event may be handled via external communication system 1030, such as using email or other notification technology.

Referring to FIG. 11, in the event of a flight disruption, the system generates an alternate travel arrangement. When a flight disruption event occurs, at 1102, the system may generate possible alternate travel arrangements, at 1104, from the primary travel source (i.e. airline flights) and then check these options against a set of rules, at 1106, determined by the traveler, such as a corporate travel policy. The alternate options are also checked against a set of rules 1106, created by the transporting entity, such as a list of fare/class rules or airline ticketing policies. The system should then determine the likely probability of success, at 1108, of an alternate travel solution, based on these rules. If no viable options meet or exceed a predetermined probability of success from the primary transportation options, an alternate subset of transportation options may then be explored, at 1110, such as private charters, car rentals, or hotel reservations. The resulting alternate travel solutions are communicated to affected parties, such as the traveling entity or travel agent, at 1112.

According to the foregoing description, various embodiments of the present invention have been described with particularity. The above-disclosed subject matter has been described in reference to particular illustrative embodiments and by way of example. The appended claims are intended to cover all modifications, variations, and other implementations which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
determining flight reservation data associated with reservations of a set of airline passengers;
determining flight status data for at least one airplane associated with the reservations of the set of airline passengers; and
determining a passenger status for each passenger in the set of airline passengers based on the flight reservation data and based on the flight status data.

2. The method of claim 1, wherein the passenger status indicates whether the flight carrying the passenger is delayed or has a high likelihood of disruption.

3. The method of claim 1, wherein the passenger status is based on a disruption condition associated with the flight of the passenger.

4. The method of claim 3, wherein the disruption condition is selected from a group of disruption levels, the disruption levels including at least two different levels.

5. The method of claim 1, wherein the set of airline passengers is determined by a travel agent and wherein the set of passengers includes those passengers where at least a portion of the travel arrangers for such set of passengers was handled by the travel agent.

6. The method of claim 1, further comprising determining that at least one of the passengers in the set of passengers has a status that indicates a flight disruption condition.

7. The method of claim 6, further comprising notifying the at least one of the passengers of the disruption condition and also providing notice of an alternate travel solution.

8. The method of claim 7, wherein the alternate travel solution includes an alternate flight (list other options).

9. The method of claim 7, further comprising rebooking the at least one of the passengers on an alternate flight.

10. The method of claim 1, wherein the set of airline passengers is associated with a plurality of different flights, at least two of the plurality of different flights on different airlines.

11. The method of claim 3, wherein the disruption condition is determined based on real-time data and based on historical data.

12. The method of claim 3, wherein the disruption condition is determined by comparing real-time airline data at various disruption points against scheduled times for the associated disruption points.

13. A system comprising:
a customer reservation subsystem;
a disruption prediction subsystem responsive to the customer reservation system;
an external communication subsystem responsive to the disruption prediction subsystem; and
an alternate travel solution subsystem responsive to the disruption prediction subsystem and providing input to the external communication subsystem.

14. The system of claim 13, further comprising a travel agency computer system, the travel agency computer system responsive to the external communication subsystem.

15. The system of claim 14, wherein the travel agency computer system includes reservation data for a plurality of passengers.

16. The system of claim 13, wherein the input to the external communication subsystem provided by the alternate travel solution subsystem includes at least one suggested alternate travel arrangement.

17. The system of claim 14, wherein the external communication subsystem sends passenger status data to the travel agency computer system, the passenger status data including a flight disruption status indication for each passenger in a set of passengers selected by the travel agency computer system.

18. The system of claim 14, wherein the travel agency computer system includes contact information associated with a passenger and wherein the travel agency computer system sends a message according to the contact information.

19. The system of claim 18, wherein the contact information includes an email address and wherein the travel agency computer system sends an email to the email address.

20. The system of claim 19, wherein the email address identifies a portable computing device carried by the passenger and wherein the message is communicated over a wireless network to the portable computing device.

21. A method of responding to a travel disruption event, the method comprising:
detecting the travel disruption event; and
using a computer system to determine an alternate travel arrangement, the alternate travel arrangement including a charter flight.

22. The method of claim 21, wherein the travel disruption event is an interruption to a commercial airline flight plan.
